(19) United States
(12) Patent Application Publication
(10) Pub. No.: US 2026/0280266 A1
(43) Pub. Date: Sep. 17, 2026

(54) SYSTEM AND METHOD FOR PROTECTING AN ACTUATING ELECTRONIC SYSTEM AGAINST AN OVER-CURRENT

(71) Applicant: SAFRAN ELECTRONICS & DEFENSE, PARIS (FR)

(72) Inventors: Martin PHAM VAN, MOISSY CRAMAYEL (FR); Joël TOUZE, MOISSY CRAMAYEL (FR); Nicolas MARTI, MOISSY CRAMAYEL (FR); Fabien BALCON, MOISSY CRAMAYEL (FR)

(21) Appl. No.: 19/472,471

(22) PCT Filed: Mar. 20, 2024
(86) PCT No.: PCT/FR2024/050335

§ 371 Date: Oct. 3, 2025

(30) Foreign Application Priority Data
Apr. 5, 2023 (FR) FR2303398

(51) Int. Cl. H02H 1/04; H02H 1/00; H02H 3/08

(52) U.S. Cl. CPC H02H 1/043; H02H 1/0061; H02H 3/08

(57) ABSTRACT

A system for electronically actuating a load, includes a control module; a transistor configured to be actuated by the control module by an electrical command in order to modify a load level; a monitoring module configured to determine a monitoring state depending on the load level, and to transmit the monitoring state to the control module; a filtering module configured to apply a delay to an evaluation of the activation or deactivation state of the load by the monitoring module: a relaxation module intended to protect the actuating system against an over-current by generating a plurality of relaxation oscillations at a terminal of the load, each relaxation oscillation being produced by: activating the transistor in a linear operation mode for an activation time determined by the relaxation module; and opening the transistor for a deactivation time determined by the relaxation module, successively to the activation time.

### TECHNICAL FIELD OF THE INVENTION

The technical field of the invention is that of activating functionalities of equipment, for example land, naval or aeronautical equipment, by means of an electronic actuation system.

The present invention relates to a system and method for protecting an electronic actuation system against an over-current.

### TECHNOLOGICAL BACKGROUND OF THE INVENTION

Electronic actuation of equipment or system functionalities requires the activation of an external load by means of a command member. This is the case, for example, for the activation of an indicator light, a solenoid valve or a servo valve in an aircraft. This command member, also referred to as a DSO (Discrete Switch Output), especially comprises a switch to serve to supply or interrupt current in the load.

Throughout its service life, the DSO may be subject to failures, in particular short circuits such as:
A short circuit in the load;
A short circuit between the DSO output and a power supply;
A short circuit between the DSO output and the reference polarising the DSO load.

In order to prevent damage in the event of a short circuit, the DSO has to be protected and the load disconnected.

From the state of the art, it is known to use a main transistor to provide the switch function, and to add a resistance in series for current measurement and a bipolar transistor to provide a current limiting function. Thus, when an over-current occurs, the voltage across the resistance is kept constant by the bipolar transistor and the main transistor is activated in a linear mode in order to dissipate power and limit the current in the load with a controlled current. In addition, there is a circuit breaker device in the load designed to open the main transistor after some period of time if the over-current is abnormally kept outside the equipment.

However, this circuit breaker system is bulky as it comprises four comparators. It also has the drawback of being sensitive and difficult to adjust. Indeed, circuit breaking can be activated by load or voltage transients. In order to avoid this, it is necessary to add an additional circuit breaker rearming device, which makes the circuit breaker system even more bulky and complex.

There is therefore a need for a means of protecting a command member during an external fault resulting in over-current that is robust, compact and low-cost.

### SUMMARY OF THE INVENTION

The invention provides a solution to the problems discussed previously by allowing protection of an electronic actuation system for an external load through the implementation of a relaxation module, which produces relaxation oscillations in the event of over-current, and the implementation of a method for interrupting an electrical command emitted by the actuation system without having to rearm circuit breaking.

A first aspect of the invention relates to an electronic actuation system for an electric load, the actuation system including:
A command module configured to emit an electrical command;
A power transistor configured to be actuated by the command module by means of the electrical command, in order to modify an activation or deactivation state of the electric load;
A control module configured to determine a control state signal as a function of the activation or deactivation state of the electric load, and to transmit the control state signal to the command module;
A filtering module configured to apply a delay to an evaluation of the activation or deactivation state of the load by the control module, prior to determining the control state by the control module;
   the actuation system comprising a relaxation module for protecting the actuation system against an over-current, the relaxation module being configured to generate one or more relaxation oscillations one after the other, each relaxation oscillation being produced, upon occurrence of the over-current, by:
Activating the power transistor in a linear operating mode for an activation duration determined by the relaxation module; and
Opening the power transistor for a deactivation duration determined by the relaxation module, the deactivation duration being consecutive to the activation duration.

By virtue of the invention, it is possible to protect the electronic actuation system by generating relaxation oscillations by means of the relaxation module. Advantageously, the relaxation module thus automatically protects the load against an over-current by generating relaxation oscillations whose amplitude and duration are controlled.

Additionally, this system is compatible with any application wherein a load is driven by means of electrical commands, the load requiring protection against over-currents, for example for land, naval or aeronautical equipment. The protection system thus obtained is advantageous because it is robust, compact and with a moderate manufacturing cost.

The filtering module compensates for any latency in the electrical circuit between the command module and the load, thereby avoiding false detection of inconsistency between the control state and the output state of the command module, after the instant when the electrical command is emitted and before the load level reaches the activation value.

Further to the characteristics just discussed in the preceding paragraphs, the actuation system according to the first aspect of the invention may have one or more of the following additional characteristics, considered individually or according to any technically possible combinations.

In one embodiment, the relaxation module comprises a current limiting circuit for limiting the external load current to a predetermined value during the activation duration, and the command module implements a circuit breaking algorithm comprising a step of commanding circuit breaking of the power transistor after a predefined actuation period, when an input of the command module is in the deactivation state.

The relaxation module thus protects the load by generating relaxation oscillations by limiting current in the power transistor and in the load. The command module automatically stops the relaxation oscillations by commanding circuit breaking of the transistor.

In one embodiment, the command module is further configured to:
Modify an output state of the command module from command data, the output state being active when the electrical command is emitted and inactive when the electrical command is not emitted;
Receive the control state signal from the control module;
Compare the control state with the output state of the command module; and
If the control state signal indicates deactivation of the load, and the output of the command module is in the active state, modify the output state of the command module to the inactive state.

By virtue of this embodiment, the actuation system is further protected from over-currents by the transistor opening, which is automatically controlled by the command module. Advantageously, protection is provided both by relaxation, generating ON/OFF flickering of the output of the electronic actuation system to the load, performed automatically by the electrical circuit of the relaxation module, and by automatic circuit breaking, for example made by means of instructions stored in a memory of the command module and implemented by a processor of said command module. By “flickering”, it is meant a cycle or a succession of periodic opening and closing cycles generated by the relaxation module.

In one embodiment, the system according to the first aspect further comprises a clock module configured to actuate comparison of the control state with the output state of the command module periodically at a predefined activation duration.

Controlling consistency between the output state of the command module and the control state is thus regularly performed, which reduces the risk of damage to the electronic actuation system, especially the command module, and the load.

In one embodiment, the relaxation module comprises a first sub-module configured to determine the activation duration, the first sub-module including:
A transistor, comprising a command connected to a voltage-dependent line of the command of the power transistor, a first and a second terminal;
A first resistance connected between the command and the first terminal of the transistor, a second resistance connected between the second terminal of the transistor and a first node, and a fourth resistance connected between the first node and the ground;
A capacitive block comprising a first capacitor connected between the first node and the ground;
A voltage generator connected between the first resistance and the collector of the transistor;
A first inverting gate, comprising an input connected to the first node and an output connected to a second node.

In one example of this embodiment, the relaxation module comprises a second sub-module configured to determine the deactivation duration, the second sub-module including:
A third resistance connected between the second node and an output of the first sub-module;
A fourth transistor, comprising a command, a first terminal connected to a command line of the power transistor to bypass the electrical command, and a second terminal connected to the ground;
A fifth resistance connected between the command and the second node;
A sixth resistance connected in parallel to the fourth transistor;
A third capacitor connected between the second node and the ground;
A diode, comprising an anode connected to the second node and a cathode connected to the output of the first sub-module;
A second inverting gate, comprising an input connected to the second node and an output connected to the fifth resistance.

By virtue of this embodiment, the relaxation module provides robust, low-overall size and low-cost protection. Advantageously, the relaxation module occupies approximately three times less surface area than a state-of-the-art system, especially one with four comparators.

A second aspect of the invention relates to an electrical device comprising a system according to the first aspect of the invention, and further comprising an electric load, wherein the system according to the first aspect is located between the load and a ground, or wherein the system is located between the load and a polarisation voltage.

A third aspect of the invention relates to an aircraft comprising the electrical device according to the second aspect of the invention.

A fourth aspect of the invention relates to a method for protecting a load actuation system against an over-current, the actuation system being according to the first aspect of the invention, the method comprising:
Activating an output state of the command module and emitting an electrical command by the command module, the electrical command being produced from command data, the electrical command actuating the power transistor to close the power transistor and to place a load level associated with the electric load to an activation value;
Generating one or more relaxation oscillations, each relaxation oscillation being produced, upon occurrence of an over-current, by:
   Activating the power transistor in a linear operating mode during an activation duration, the activation duration being determined by the relaxation module, the load level being equal to a limit value during the activation duration;
   Opening the power transistor for a deactivation duration consecutive to the activation duration, the deactivation duration being determined by the relaxation module, the load level being zero during the deactivation duration;
Detecting a modification in the load level by the control module after a delay applied by the filtering module, determining a control state by the control module as a function of the modified load level, and transmitting the control state to the command module via a control state signal;
Comparing by the command module the control state with the output state; and
If the control state signal indicates deactivation of the load, and the output of the command module is in the active state, modifying the output state of the command module to the inactive state.

By virtue of this second aspect, it is possible to robustly and reliably protect the load and the actuation system by jointly implementing relaxation of the system output according to the invention by means of the relaxation module and circuit breaking automatically performed by the command module. In addition, the delay imposed by the filtering module makes it possible to compensate for a possible latency in the electrical circuit between the command module and the load, and to avoid false detection of inconsistency between the control state and the output state of the command module at the instant when the electrical command is emitted and before the load level reaches the activation value.

In one embodiment, the actuation system further comprises a clock module, and comparing the control state with the output state of the command module is periodically performed at a comparison period defined by the clock module.

Controlling consistency between the output by the module and the control state is thus regularly performed, which reduces the risk of damage to the electronic actuation system, especially the command module and the load.

A fifth aspect of the invention relates to a computer program comprising instructions which, when the program is executed on a calculator, cause the same to implement the steps of the method according to the second aspect of the invention.

A sixth aspect of the invention relates to a computer-readable recording medium comprising instructions which, when executed by a computer, cause the same to implement the steps of the method according to the second aspect of the invention.

The invention and its different applications will be better understood upon reading the following description and upon examining the accompanying figures.

### BRIEF DESCRIPTION OF THE FIGURES

The figures are set forth by way of indicating and in no way limiting purposes of the invention.

FIG. 1 is a schematic representation of an actuation system according to one exemplary embodiment of the invention.

FIG. 2 is a schematic representation of a relaxation module included in the actuation system.

FIG. 3 is an example of the electrical circuit of the actuation system according to a first embodiment.

FIG. 4 is a block diagram illustrating the sequence of steps in a method according to one exemplary embodiment of the invention.

FIG. 5 is a graph showing the course over time of the main physical quantities involved in the actuation system.

FIG. 6 is an example of the electrical circuit of the actuation system according to a second embodiment.

### DETAILED DESCRIPTION

Unless otherwise specified, a same element appearing in different figures has a single reference.

A first aspect of the invention relates to an electronic actuation system for actuating functionalities of the equipment, for example land, naval or aeronautical equipment. By way of example, the electric load making the functionality is an indicator light, a servo valve, an engine stop command, a solenoid valve, etc. The electric load is, for example, an electric load present in an aircraft, such as an aircraft with a rotary wing or a fixed wing. The functionality is activated by a modification in the current supplying it.

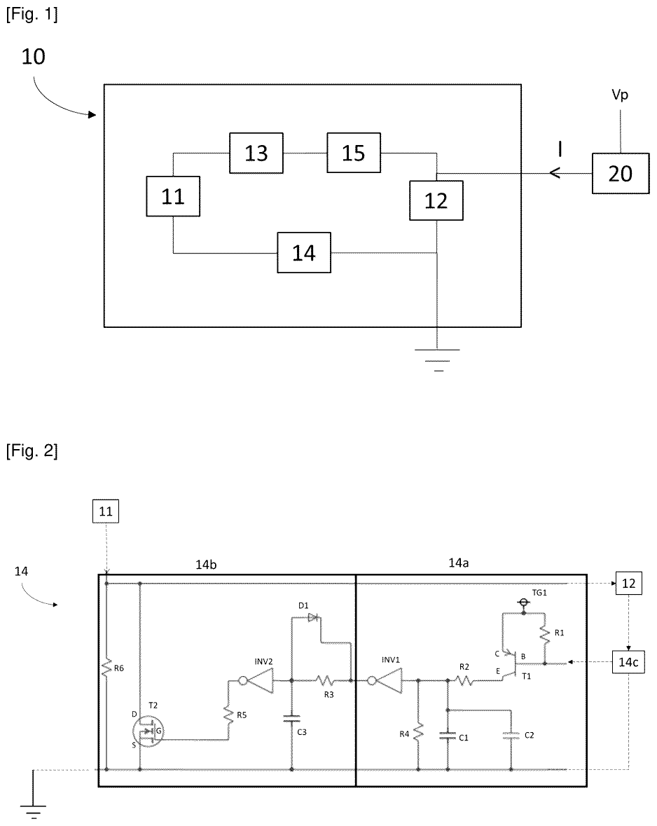

The electronic actuation system 10 is depicted in FIG. 1 and comprises:
A command module 11;
A transistor 12;
A control module 13;
A relaxation module 14; and
A filtering module 15.

The actuation system 10 comprises an output connected to the electric load 20, i.e. an external load 20, to supply and drive the functionality external to the equipment, i.e. the external load 20. A current I flows in this load represented at this output. A modification, by the actuation system 10, of this current I allows the functionality to be activated or deactivated.

By “connected” or “linked” it is meant connection in the form of an electrical circuit between one element and another. This refers, for example, to a connection by electrical wires directly stretched between the elements or via other elements, not represented, serving as connection intermediaries, such as a prototyping board, a transmitter/receiver device, a transformer, a resistance, a coil, etc.

The command module 11 is configured to send one or more electrical commands to the power transistor 12 in order to activate it (the transistor is also said to be closed or saturated) or deactivate it (the transistor is also said to be open or blocked). When the power transistor 12 is activated, it allows current I to flow from the output to the ground. The command module 11 thus comprises an output CMD for sending the electrical command to the power transistor 12 via a command line from the relaxation module 14 connecting a command from the power transistor 12 to the output CMD. The command module 11 also comprises an input MON, connected to the control module 13. The input MON allows the command module 11 to receive a control state determined by the control module 13.

The command module 11 is preferably an integrated circuit comprising a processor, a volatile memory and/or a non-volatile memory, as well as the input MON and the output CMD. Preferably, the command module 11 is a microcontroller. The advantage of a microprocessor is that it natively includes integrity tests, which makes the comparison of data received at its input MON with data transmitted at its output CMD robust.

By “electrical command”, it is meant an electrical signal emitted by the command module 11 from its output CMD, and whose reception by the power transistor 12 activates it—especially to open or close the transistor 12—in order to modify the current I in the external load 20. The electrical command is determined by the command module 11 as a function of command data. The command data are digital or analogue data transmitted to the command module 11 or contained in the memory of said command module 11 and indicate to the command module 11 how and/or when to determine and/or transmit the electrical command. Activating the transistor 12 thus makes it possible to activate the desired functionality of the external load 20.

Upon emitting the electrical command, an output state of the command module 11 is activated by the command module 11. The output state is preferably a binary variable that indicates whether or not the command is emitted. For example, the output state takes the value
0 or a low value L when the command is not emitted, the output state is then inactive or deactivated.
1 or a high value H when the command is emitted, the output state is then active.

As long as the output state is active, the electrical command is emitted by the command module 11.

The transistor 12 is preferably a field effect transistor. For example, transistor 12 is an N-type or P-type enhancement mode MOSFET (Metal Oxide Semiconductor Field Effect Transistor). The transistor 12 comprises a drain, a source, and a gate. Depending on the application, the source, drain and gate are directly or indirectly connected to the other modules of the system 10 and to the external load 20. The transistor 12 is connected to the command module 11 via the command line of the relaxation module 14, and one of its terminals is connected to the control module 13 and the external load 20, and the other terminal is connected to the ground in this example (or to a voltage in another example). The filtering module 15 is connected between the control module 13 and the transistor 12.

It is alternatively possible that the transistor 12 is a bipolar transistor. In this case, a voltage divider bridge is integrated into the actuation system 10 on the base of the transistor 12 in order to adapt the voltage across the bipolar transistor 12.

The actuation system 10 may also comprise an adaptation stage, not represented, between the command module 11 and the transistor 12, in order to adapt the voltage of the output CMD to the voltage supported by the transistor 12.

The control module 13 is configured to determine the control state to be transmitted to the command module 11. The control module 13 is, on the one hand, connected to the command module 11 and, on the other hand, to the external load 20. The control module 13 is connected to a node between the external load 20 and the transistor 12, possibly via the filtering module 15 when the same is present. The control state is determined as a function of a load level. The control state is preferably a binary variable. The control state takes, for example, a value of 0 or 1. The control state can also take a high value H or a low value L. The control module 13 thus transmits a signal (digital or analogue) corresponding to the control state, i.e. either a load activation state corresponding to a load activation value or a load deactivation state corresponding to a load deactivation value.

By “load level” of the external load 20, it is meant the value of the current I flowing through the external load 20, allowing activation or deactivation of the load. By activation of the external load 20, it is meant the activation of the desired functionality when current I flows through the load, either when power supplied via the power transistor closed or even in the case where current I flows through the external load 20 with the power transistor open. According to one example, the control module can receive information about the load level by performing a measurement of a current at the high level of the load (an example of a measurement principle is a Hall effect current sensor between the +terminal and the load). When the electrical command is emitted by the command module 11 at its output CMD to activate the functionality, the load level changes to an activation value I₀. By “activation value”, it is meant the intensity reached by the current I in the external load 20 necessary to activate the functionality. When the power transistor 12 is open, the load level is close to a zero value. Below, it is explained that the power transistor 12 can also be commanded in a linear operating mode via the relaxation module 14. In this case, the load level is equal to a limit value Iₗᵢₘ. The limit value Iₗᵢₘ is predefined depending on the application, for example by the relaxation module 14. In linear operating mode, the gate of the power transistor 12 is polarised and the power transistor 12 becomes resistive, which limits current passing therethrough. The potential difference between the gate and source of power transistor 12 is therefore limited so that power transistor 12 is in linear operating mode.

Thus, the control state takes on a different value to correspond to the load level, especially when the load level is equal to the activation value, the limit value or is zero. By way of example, the control state is:
The activation state has a value of H (or 1) when the load level is equal to the activation value or the limit value Iₗᵢₘ;
The deactivation state has a value of L (or 0) when the load level is zero.

The control state corresponds to the activation state when the load level is equal to the limit value Iₗᵢₘ provided that the electronic actuation system 10 does not include the relaxation module 14 and the filtering module 15. When the two latter modules are present, the relaxation module 14 limits the time interval during which I=Iₗᵢₘ, and the filtering module 15 masks the high state.

The load level is continuously evaluated by the control module 13, since the control module 13 is connected (directly or indirectly) to the external load 20. Alternatively, the load level may be periodically evaluated by the control module 13, at a predetermined control period depending on the application.

The control module 13 is configured to detect a modification in the load level. Upon detecting modification, the control state is modified to correspond to the load level modified.

The load level is preferably measured by means of an operational amplifier (not represented) that detects the voltage level between the power transistor 12 and the load. The operational amplifier allows this voltage level to be compared to a reference voltage. The voltage is low when power transistor 12 is closed and high when it is open. When power transistor 12 is in the linear operating mode, the voltage detected by the operational amplifier is high.

The filtering module 15 serves as a connection intermediary between the control module 13 and the external load 20. In this case, the control module 13 is, on the one hand, connected to the command module 11 and, on the other hand, to the filtering module 15. The control module 13 is then no longer connected directly to the external load 20, but via the filtering module 15. The filtering module 15 is configured to apply a delay t_{MON} to the evaluation of the load level by the control module 13. That is, when a modification in the current I in the external load 20 occurs, this change is not instantly reflected in the control module 13 but is delayed by a delay equal to the delay t_{MON} applied by the filtering module 15.

The purpose of such a filtering module 15 is to compensate for a possible latency during the transfer of the electrical command from the command module 11 to the power transistor 12, in order to ensure consistency between the output state and the control state upon emitting the electrical command. The filtering module 15 also makes it possible to create an “erroneous” state between the output CMD and the input MON when the relaxation module 14 is activated. Without this filtering module 15, the control state at the input MON follows the same oscillations as the relaxation, that is oscillations with a high oscillation frequency. With this filtering module 15, the control state of the input MON remains in the low state while the oscillations take place.

The control module 13 is, in its operation, equivalent to a diode in series with a polarisation resistance: when power transistor 12 is closed, current flows through the diode and the polarisation resistance and the control state takes, for example, the low value L or 0; when power transistor 12 is open, the diode is blocked and the control state takes, for example, the high value H or 1.

The relaxation module 14 is configured to generate one or more relaxation oscillations when an over-current occurs at the output of the actuation system 10, for example in the event of a short circuit on the external load 20 or a short circuit of the power transistor 12 at the polarisation voltage Vp of the external load 20. The over-current occurs, for example, due to a short circuit caused by the failure of an element of the external load 20, such as a faulty coil whose resistance becomes zero, or when two or more connector assemblies touch each other on a connector.

In the event of an external fault resulting in an over-current, power transistor 12 enters a linear operating mode and current I is limited to the limit value Iₗᵢₘ. Relaxation module 14 detects this over-current and forces power transistor 12 to open for a deactivation time T_{OFF}, after an activation time T_{ON} during which the transistor is in linear operating mode. The activation time T_{ON} and the deactivation time T_{OFF} are defined by the relaxation module 14 and their respective durations depend on the application. Preferably, the activation time T_{ON} is much shorter than the deactivation time T_{OFF}. The activation time T_{ON} makes it possible to mask current transients such as inrush currents upon activating the external load 20, transients due to lightning strikes, and transients in the polarisation voltage Vp of the external load 20.

In one alternative, it is possible to generate the over-current artificially by means of an over-current module (not represented), example a switch. This over-current module polarises voltage between the transistor 12 and the load 20 with a voltage adapted to generate the over-current. The advantage of this over-current module is, on the one hand, to be able to check proper functioning of the actuation system 10, especially to trigger protection, and, on the other hand, to force triggering the protection in the event of a failure of the over-current detection by the actuation system 10.

The sequence of the activation duration T_{ON} and the deactivation duration T_{OFF} is a relaxation. The repetition of the relaxation according to a relaxation period causes relaxation oscillations. The relaxation period is greater than or equal to the sum of the activation duration T_{ON} and the deactivation duration T_{OFF}. The relaxation period is defined depending on the application. The T_{ON}/T_{OFF} duration ratio can be determined by the relaxation module 14, taking account of the powers dissipated by the components of the actuation system 10, and especially the power transistor 12.

In other words, relaxation oscillations are an artificial, electrically driven periodic phenomenon produced by limiting and then cutting off the current by virtue of the activation of the power transistor 12. This oscillation phenomenon allows the control module 13 to detect that the desired functionality is not activated.

Preferably, the activation time T_{ON} is sufficiently long so that power transistor 12 does not open during load or voltage transients. By a “transient”, it is meant a very short duration over-current or overvoltage, i.e. with a duration that is very short compared to the time constant for establishing the current in the load, making this transient phenomenon virtually instantaneous. The transient generally lasts less than 1 ms, for example in the order of 100 μs for a load transient and in the order of 300 μs for a voltage transient such as an impact of lightning. Thus, the activation time T_{ON} is at least greater than the duration of the longest transient phenomenon, and preferably in the order of 1 ms or greater than or equal to 1 ms.

Preferably, the activation duration T_{ON} is greater than or equal to ten times the duration of a transient phenomenon. The activation duration T_{ON} is at least greater than or equal to five times the duration of a transient phenomenon.

Further, the activation duration T_{ON} is sufficiently long so as not to trigger relaxation oscillations upon emitting the electrical command, in the case where an over-current is transitorily necessary to activate the desired functionality.

The deactivation duration T_{OFF} may be in the order of ten times the activation duration T_{ON}, so that the control module 13 detects the zero current of the output and reduces stresses on the filtering module 15 upstream of the control module 13. For example, the deactivation time T_{OFF} is greater than or equal to five times the activation time T_{ON}, or is greater than or equal to ten times the activation time T_{ON}. The deactivation time T_{OFF} may be longer in order to allow a single activation before circuit breaking.

According to the preceding example, the control state therefore takes a value equal to 0 or L during the deactivation duration T_{OFF}. The filtering module 15 then maintains the control state in the deactivation state during the activation duration T_{ON}.

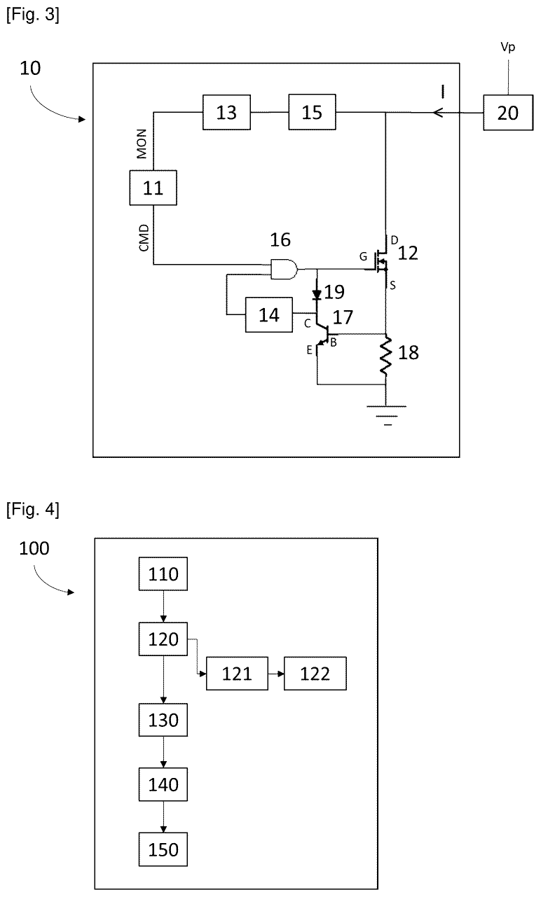

As shown in FIG. 2, the relaxation module 14 comprises a first sub-module 14a configured to determine the activation duration T_{ON} and to limit the current I during the activation duration T_{ON}, as well as a second sub-module 14b configured to determine the deactivation duration T_{OFF} and to open the power transistor 12. The relaxation module 14 also comprises a limiting sub-module 14c for limiting the current I to the limit value Iₗᵢₘ in the event of over-current. The limiting sub-module 14c comprises a current measurement resistance in series with the power transistor 12 and a shunt line from the command of the power transistor 12 to shunt part of the current from the electrical command and thus limit the current I, the power transistor 12 then switching to a linear operating mode. The shunt line comprises a limiting transistor whose command (base) is connected between the measurement resistance and the power transistor 12, a first terminal, for example the collector, connected to the command of the power transistor 12 (optionally via a diode and/or a resistance) and the other terminal, for example an emitter, connected to the ground. FIG. 3 represents a current limiting module which may be this limiting sub-module 14c but integrated into the relaxation module.

The first sub-module 14a comprises:
A transistor T1, comprising a command, herein a base B, connected to a line dependent on the voltage of the power transistor 12 command, a first terminal, herein a collector C, and a second terminal, herein an emitter E;
A first resistance R1 connected between the command (base B) and the first terminal (collector C) of transistor T1, a second resistance R2 connected between the second terminal (emitter E) and a first node, and a fourth resistance R4 connected between the first node and the ground;
A capacitive block comprising a first capacitor C1 and a second capacitor C2 connected in parallel between the first node and the ground (there may be one or more in parallel);
A voltage generator TG1 connected between the first resistance R1 and the collector C;
A first inverting gate INV1, for example a Schmitt trigger, comprising an input connected to the first node and an output connected to a second node; and
In this embodiment, represented in FIGS. 2 and 3, herein the line dependent on the control voltage of power transistor 12 connected to connect to the command of transistor T1, may be connected to a node between a cathode of a diode 19 connected to the command of power transistor 12 and a first terminal (collector) of limiting transistor 17.

Alternatively, the limiting sub-module 14c is not included in the relaxation module 14. In this case, the limiting module is replaced by an over-current detection module comprising, on the one hand, resistance 18 in series with power transistor 12 for current measurement and, on the other hand, transistor 17 commanded according to the voltage across resistance 18 to detect over-current. In other words, the line dependent on the control voltage of the power transistor 12 is connected to a node connected to the command of the power transistor 12 and to the first terminal of the limiting transistor 17.

However, as can be seen in the embodiment represented, the addition of diode 19 allows, further to over-current detection, the current to be limited and thus the components of the electronic actuation system 10 to be protected.

The output of the limiting sub-module 14c is connected to the input of the first sub-module 14a on the link between the first resistance R1 and transistor T1.

Additionally, the output of the first inverting gate INV1 is connected to the second sub-module 14b.

The second sub-module 14b comprises:
A third resistance R3 connected between the second node and an output of the first sub-module 14a (the output of the first inverting gate INV1);
A fourth transistor T2, comprising a command, herein a gate G, a first terminal, herein a drain D, connected to the command line of the power transistor to bypass the electrical command, and a second terminal, herein a source S, connected to the ground;
A fifth resistance R5 connected between the gate G and the second node;
A sixth resistance R6 connected in parallel to the fourth transistor T2;
A third capacitor C3 connected between the second node (i.e. to the third resistance) and the ground;
A diode D1, connected in parallel to the third resistance R3, comprising a cathode connected to the input of the second sub-module 14b (therefore to the output by the first sub-module 14a) and an anode connected to the second node;
A second inverting gate INV2, for example another Schmitt trigger, comprising an input connected to the second node and an output connected to the fifth resistance R5.

Specific features of the elements of the two sub-modules are as follows:
The first resistance R1=2.15 kΩ;
The second resistance R2=47 kΩ;
The third resistance R3=100 kΩ;
The fourth resistance R4=33 kΩ;
The fifth resistance R5=100 Ω;
The sixth resistance R6=39.2 kΩ;
The first and third capacitors C1, C3=22 nF;
The second capacitor C2=10 nF;
Transistor T1 is a PNP bipolar transistor;
The fourth transistor T2 is a P-channel depletion-mode MOSFET.

It will be noted that each resistance can be formed by a set of resistances and each capacitive block by a set of capacitors.

The actuation system 10 may further comprise a clock module (not represented). The clock module is preferably an integrated circuit of the RTC type, which stands for “Real-Time Clock”. The clock module may be included in one of the modules of the actuation system 10, for example in the command module 11, or may be an independent module. The clock module is configured to produce a clock signal to the command module 11 in order to trigger comparison between the control state and the output state. The clock signal is, for example, an electrical signal which, when received by the command module 11, causes the control state to be compared with the output state of the command module 11. The clock signal is preferably emitted periodically at the control period t_{RTC}. The control period t_{RTC} is defined by the clock module depending on the application. The T_{OFF}/t_{RTC} ratio depends on the number of desired oscillations and depends on the target application. The deactivation time T_{OFF} may be longer than the control period t_{RTC} to trigger circuit breaking after the first activation.

In order to avoid detection of an inconsistency during the delay t_{MON}, the control period t_{RTC} should meet one of the following conditions:
The control period t_{RTC} must be greater than the delay t_{MON};
The first comparison of the control state with the output state of the command module 11 must be performed after N implementations of the control period t_{RTC} from emission of the command, where N is a real number such that N*t_{RTC}>t_{MON}.

Alternatively, the clock module is a set of computer instructions which, when executed by a calculator, cause emission of a signal to trigger the comparison between the control state and the output state.

The role of the clock module is to limit the number of relaxation oscillations generated by the relaxation module 14, by applying the control period t_{RTC}.

One exemplary embodiment of the actuation system 10 is provided in FIG. 2. The application relates to a FADEC (Full Authority Digital Engine Control) engine calculator in a helicopter, commanding functions such as indicator lights, solenoids and solenoid valves. In this embodiment, the actuation system 10 controls actuation of its power transistor 12 located between ground and the external load 20; this is referred to as a Ground Open electronic actuation system 10.

In FIG. 3, the actuation system 10 comprises the previously mentioned modules (command module 11, control module 13, relaxation module 14 and filtering module 15) and the power transistor 12. The system 10 also comprises an AND type logic gate 16, a current limiter module comprising a limiting transistor 17, the measurement resistance 18 and a diode 19. In this case, the voltage generator TG1 of the first sub-module 14a generates a voltage of the same order of magnitude as the output voltage of the logic gate 16 so as to block the diode 19 when the output voltage of the logic gate 16 becomes zero.

The measurement resistance 18 is connected in series with the power transistor 12, herein between the transistor 12 and the ground. Thus, the voltage across the resistance 18 depends on its resistive value and the current I flowing through the external load 20.

The logic gate 16 comprises a first input connected to the output CMD of the command module 11, a second input connected to an output of the relaxation module, and an output 16a connected to a control node connected to the power transistor command. Diode 19 comprises an anode connected to the command node and a cathode connected to a first terminal, herein a collector C of the limiting transistor 17. The second terminal, herein an emitter E, of the limiting transistor 17 is connected to the ground, so that the limiting transistor allows the electrical command signal coming out of output 16a of logic gate 16 to be derived. The limiting transistor 17 further comprises a command, herein a base B, connected between the measurement resistance 18 and the power transistor 12. Thus, the command of the limiting transistor 17 is directly dependent on the current passing through the measurement resistance 18. If the current I is too high (greater than a maximum voltage Imax), the voltage Vbe (voltage between the first terminal, herein a collector C, and the second terminal, herein the emitter E, of the limiting transistor 17) closes the limiting transistor 17, which derives the electrical command, and if the current I is normal (less than I₀), the voltage Vbe is insufficient and the limiting transistor 17 is open, allowing the electrical command to close the power transistor 12. In operation, when the current I is between I₀ and Imax, the limiting transistor 17 is in linear mode and draws part of the current from the electrical command of the power transistor 12, which then also switches to linear mode, reducing the current until it is equal to Ilim. This block thus limits the current I to Ilim (it never reaches Imax).

The control module 13 is, on the one hand, connected to the filtering module 15 and, on the other hand, to the MON output.

In this embodiment, the external load 20 is constantly connected to a polarisation voltage Vp and is connected to the ground only if the power transistor 12 is closed. The system 10 is therefore located between the load 20 and the ground.

Thus, when the electrical command is emitted and the limiting transistor 17 is open, the voltage at the command of the fourth transistor T2 is zero and the logic gate 16 produces a non-zero voltage at its output 16a, which allows the power transistor 12 to be activated in saturated mode and the functionality to be activated. And then, when the over-current occurs, the limiting transistor 17 is powered and can either be saturated (close) or switch to linear mode. The voltage at the command of the fourth transistor T2 is then non-zero and the second input of logic gate 16 is then connected to the ground, resulting in a zero voltage at output 16a after the activation time T_{ON}. The power transistor 12 is then open, causing the current limiter 17 to open, which allows the relaxation module 14, after the activation time T_{OFF}, to send a signal to logic gate 16 so that at output 16a the electrical command from the output COM supplies the power transistor 12 in linear (or saturated) mode, and so on. In other words, the relaxation module generates relaxation oscillations causing, at output 16a of logic gate 16, open or close (1 or 0) electrical commands causing the power transistor 12 to operate in linear or closed (saturated) mode, as a function of the operation of the limiting transistor 17, or in open (blocked) mode. This electrical mechanism automatically protects the external load 20 from over-current.

A second aspect of the invention relates to a method of protecting the actuation system 10 against an over-current. Method 100, the sequence of steps of which is summarised in FIG. 4, comprises five steps numbered 110 to 150.

The relaxation module 14 may generate conducted emissions in electrical harnesses outside the actuation system 10. Conducted emissions are disturbances generated at regular intervals of load current transients, herein produced by relaxation oscillations. In order to limit the risk of conducted emissions, the actuation system 10 is disconnected after some time by the microcontroller detecting an inconsistency between the output state at the output CMD of the control module and the control state at the input MON.

The first step 110 is a step of activating the output state by the command module 11 and emitting the electrical command by the command module 11. The electrical command is generated from the command data. The electrical command actuates the power transistor 12 to close said power transistor 12 and to place the load level to the activation value I₀.

After applying the delay t_{MON} by the filtering module 15, the control module 13 detects the modification in the load level and determines the control state to correspond to the activation value I₀. For example, the control state takes the high value (H or 1). Respectively, the activated output state can take the high value (H or 1).

The second step is then a step of generating 120 the relaxation oscillation(s). Relaxation oscillations are variations in the current I through the external load 20. Relaxation oscillations are produced by the relaxation module 14 when over-current occurs. Each relaxation oscillation is produced by a sequence of two sub-steps 121 and 122.

The first sub-step 121 is a step of activating power transistor 12 in a linear operating mode during the activation duration T_{ON}. During the activation duration T_{ON}, the load level is equal to the limit value Iₗᵢₘ. The limit value Iₗᵢₘ is imposed on the current I by the limiting sub-module 14c. The linear mode of the power transistor 12 is automatically activated by the limiting transistor 17 upon occurrence of over-current.

The second sub-step 122 is a step of opening the power transistor 12 for the deactivation time T_{OFF}, after the activation time T_{ON}. By opening the power transistor 12, the load level is zero during the deactivation duration T_{OFF}. Opening the transistor is carried out by the relaxation module 14, which cancels the output 16a of the logic gate 16.

The third step is then a step 130 of detecting modification of the load level and modification of the control state as a function of the load level modified by the control module 13. The third step 130 also comprises transmitting the control state to the command module 11.

When the modification in current I happens upon occurrence of the over-current, through the phenomenon of relaxation oscillations, this modification is transmitted to the control module 13 with a time delay equal to the delay t_{MON}. The modification in the load level is therefore detected by the control module 13 after the delay t_{MON} applied by the filtering module 15, and the control state indicating this modification is therefore only determined after this delay t_{MON}.

The fourth step is then a step 140 of comparing, by the command module 11, the control state indicating the modification in load level, with the output state. The fourth step 140 beforehand comprises receiving the control state by the command module 11.

The comparison makes it possible to determine whether the output state and the control state are consistent with each other. The aim herein is to verify that the activation of the power transistor 12 is in accordance with the electrical command emitted. Four scenarios are then especially possible:
If the output state indicates that a command is emitted and the control state indicates that the transistor is closed, there is consistency between the output state and the control state;
If the output state indicates that a command is emitted, and if the control state indicates that the transistor is open, there is an inconsistency between the output state and the control state;
If the output state indicates that a command is not emitted, and the control state indicates that the transistor is open, there is consistency between the output state and the control state;
If the output state indicates that a command is not emitted, and if the control state indicates that the transistor is closed, there is an inconsistency between the output state and the control state; this may further indicate that power transistor 12 is short circuited to the ground or that load 20 is short circuited to the ground.

The fifth step is then a step of deactivating 150 the control state by the command module 11 when the control state is not consistent with the output state. The command module 11 then stops emitting the electrical command to the power transistor 12.

If there is consistency between the output state and the control state, the fourth step 140 is periodically repeated at the control period t_{RTC} defined by the clock module, until inconsistency between the output state and the control state is detected.

Further, comparing the output state with the load state can be implemented at any time after emitting the electrical command, regardless of the occurrence of over-current. This makes it possible to verify that the command emitted has actually been taken into account by power transistor 12 to activate the desired functionality. The comparison of the output state with the load state is preferably initialised after the delay t_{MON}, in order to take into account any time delay between transmitting the electrical command and activating the power transistor 12.

The comparison of the output state with the load state may also be implemented periodically, at the control period t_{RTC} defined by the clock module.

The command module 11 comprises instructions in its memory, for example in its non-volatile memory, which, when executed by its processor, cause the implementation of:
In the first step 110, activating the output state of the command module 11 and emitting the electrical command;
In the fourth step 140, receiving the control state determined by the control module 13 in the third step 130;
Still in the fourth step 140, comparing the control state with the output state; and
In the fifth step 150, deactivating the output state when the control state is not consistent with the output state.

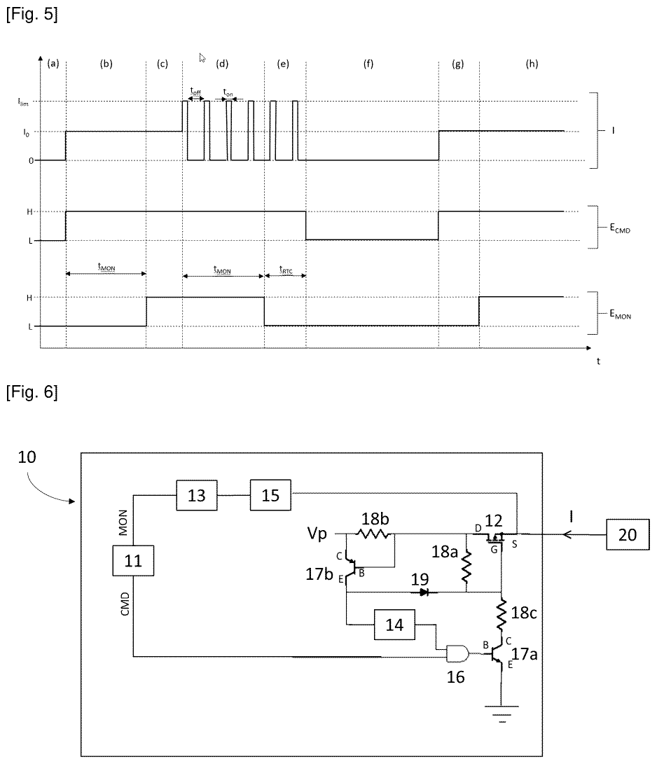

FIG. 5 represents a diagram of the course of the output state E_{CMD}, the control state E_{MON} and the current I over time. The diagram is broken down into several phases numbered from (a) to (h). The time scale t used is in no way representative of the actual operation of the actuation system 10 and is used here for illustrative purposes only.

During phase (a), prior to emitting the electrical command of the first step 110:
The output state E_{CMD} is at a low value L,
The control state E_{MON} is at a low value L,
And the current I, therefore the load level, is zero.

At the start of phase (b), the electrical command is emitted, in accordance with the first step 110. The duration of phase (b) corresponds to the delay t_{MON} and during this phase:
The output state E_{CMD} is at a high value H,
The control state E_{MON} is at a low value L,
And the current I, therefore the load level, is at the activation value I₀.

If over-current occurs during phase (b), the control state E_{MON} remains at the low value and the output state E_{CMD} will automatically switch to the low value L after detecting the inconsistency at the end of the control period t_{RTC}.

At the start of phase (c), after the delay t_{MON} imposed by the filtering module 15, the modification in the load level, that is the current I to the activation value I₀, is detected by the control module. During phase (c):
The output state E_{CMD} is at a high value H,
The control state E_{MON} is at a high value H
And the current I, therefore the load level, is at the activation value I₀.

At the start of phase (d), over-current happens. During phase (d), relaxation module 14 generates relaxation oscillations, in accordance with the second step 120, to protect the actuation system 10 from possible damage. The duration of phase (d) is equal to the delay t_{MON}. In this example, several relaxation oscillations are generated in the relaxation period of phase (d) and:
The output state E_{CMD} is at a high value H,
The control state E_{MON} is at a high value H
And the current I, therefore the load level, is at the limit value Iₗᵢₘ during the activation duration T_{ON} and zero during the deactivation duration T_{OFF}.

If a single relaxation oscillation is generated, i.e. when T_{OFF} is very large compared to t_{RTC} (T_{OFF}>>t_{RTC}), then the system will disconnect after the first oscillation following detection of the inconsistency, at the end of the control period t_{RTC}.

In phase (e), the relaxation oscillations continue and control module 13 detects the modification in load level after the control period t_{RTC}, in accordance with the third step 130:
The output state E_{CMD} is at a high value H,
The control state E_{MON} is at a low value L,
And the current I, therefore the load level, is at the limit value Iₗᵢₘ during the activation duration T_{ON} and zero during the deactivation duration T_{OFF}.

At the start of phase (f), the relaxation oscillations have ceased and the inconsistency between the output state and the control state is detected by the command module 11, in accordance with the fourth and fifth steps 140 and 150. The power transistor 12 is then open. Phase (f) lasts until a new electrical command is emitted to activate power transistor 12. During phase (f):
The output state E_{CMD} is at a low value L,
The control state E_{MON} is at a low value L,
And the current I, therefore the load level, is zero.

At the start of phase (g), a new electrical command is emitted and the actuation system behaves as it does during phase (b). During phase (h), the output state is modified to take account of the activation of power transistor 12, as is the case for phase (c).

Another exemplary embodiment of the actuation system 10 is provided in FIG. 6. The application again relates to the FADEC (Full Authority Digital Engine Control) engine calculator of the helicopter. In this embodiment, the actuation system 10 controls actuation of its power transistor 12 located between the polarisation voltage Vp and the external load 20; this is referred to as Polarisation Open commanded electronic actuation system 10.

In FIG. 6, the actuation system 10 comprises the previously mentioned modules (command module 11, control module 13, relaxation module 14 and filtering module 15) and the power transistor 12. The system 10 also comprises the AND type logic gate 16, a fifth transistor 17a, a sixth transistor 17b, a seventh resistance 18a, an eighth resistance 18b, a ninth resistance 18c and the diode 19. The power transistor 12 is preferably a PMOS (P-channel Metal—Oxide—Semiconductor) to facilitate command.

The logic gate 16 comprises a first input, a second input and an output. The diode 19 comprises an anode and a cathode. The fifth and sixth transistors 17a and 17b each comprise a base B, a collector C and an emitter E.

The first input of the logic gate 16 is connected to the output CMD of the command module 11. The second input of the logic gate 16 is connected to the relaxation module 14, and the output of the logic gate 16 is connected to the base B of the fifth transistor 17a.

The emitter E of the fifth transistor 17a is connected to the ground.

The relaxation module 14 is additionally connected to the emitter E of the sixth transistor 17b.

The collector of the sixth transistor 17b is connected to the polarisation voltage Vp.

The eighth resistance 18b is connected to the link between the polarisation voltage Vp and the sixth transistor 17b. The eighth resistance 18b is additionally connected to the drain of the power transistor 12.

The collector C of the fifth transistor 17a is connected to the ninth resistance 18c, which is additionally connected to the gate of the power transistor 12.

The source of power transistor 12 is connected to the external load 20.

The filtering module 15 is connected to the link between the power transistor 12 and the external load 20.

The control module 13 is connected to the filtering module 15, on the one hand, and to the input MON of the command module 11, on the other hand.

The diode 19 is placed in parallel, from the anode to the cathode of said diode 19, between the emitter E of the sixth transistor 17b and the ninth resistance 18c.

The base B of the sixth transistor is connected to the link between the eighth resistance 18b and the power transistor 12.

The seventh resistance 18a is in parallel between the cathode of diode 19 and the drain D of power transistor 12.

In this embodiment, the external load 20 is connected to a polarisation voltage Vp when the transistor is closed and is isolated from the polarisation voltage Vp when the power transistor 12 is open. The relaxation module 14 is therefore located between the load and the polarisation voltage.

Thus, in the event of a short circuit during the activation duration T_{ON}, the sixth transistor 17b switches to linear operating mode and the gate of the power transistor 12 is polarised by the polarisation voltage Vp, through the sixth transistor 17b and the diode 19. This keeps the power transistor 12 in linear operating mode and limits the current in the external load 20. During this time, relaxation oscillations occur. At the end of the activation time T_{ON}, the output of the logic gate 16 becomes zero and the fifth transistor 17a is then open. Power transistor 12 is thus blocked since the voltage Vos between its source S and gate G is zero. This electrical mechanism automatically protects command module 11 from over-current.

The invention provided therefore offers the dual advantage that the relaxation module 14 takes up little space in the actuation system 10 and that the circuit breaking is precisely timed while protecting the actuation system 10 so that it is not impacted by the transient phenomenon, thus avoiding false triggering of the circuit breaking due to over-current. Furthermore, if non-detection of the inconsistency occurs, for example in the event of a malfunction of the control module 13 or an erroneous electronic command, the actuation system 10 remains protected by the relaxation oscillations generated by the relaxation module 14. Finally, in the event of a malfunction of the relaxation module 14 resulting in the non-generation of relaxation oscillations, the current I flowing in the load is limited to the value Iₗᵢₘ. The transistor 12 may break due to the undissipated overload, thereby insulating and protecting the actuation system 10 against the over-current of the load 20.

1. An electronic actuation system for an electric load, the actuation system comprising:
a command module configured to emit an electrical command;
a power transistor configured to be actuated by the command module by means of the electrical command, in order to modify an activation or deactivation state of the electric load;
a control module configured to determine a control state signal as a function of the activation or deactivation state of the electric load, and to transmit the control state signal to the command module;
a filtering module configured to apply a delay to an evaluation of the activation or deactivation state of the load by the control module, prior to determining the control state by the control module, and
a relaxation module for protecting the actuation system against an over-current, the relaxation module being configured to generate one or more relaxation oscillations one after the other, each relaxation oscillation being produced, upon occurrence of the over-current, by:
activating the power transistor in a linear operating mode for an activation duration, determined by the relaxation module; and
opening the power transistor for a deactivation duration determined by the relaxation module the deactivation duration being consecutive to the activation duration.

2. The system according to claim 1, wherein the relaxation module comprises a current limiting circuit for limiting the external load current to a predetermined value during the activation duration, and the command module implements a circuit breaking algorithm comprising a step of commanding circuit breaking of the power transistor after a predefined actuation period, when the control state signal indicates deactivation of the load.

3. The system according to claim 1, wherein the command module is further configured to:
modify an output state of the command module from command data, the output state being active when the electrical command is emitted and inactive when the electrical command is not emitted;
receive the control state signal from the control module;
compare the control state with the output state of the command module; and
when the control state signal indicates deactivation of the load, and the output of the command module is in the active state, modify the output state of the command module to the inactive state.

4. The system according to claim 1, further comprising a clock module configured to actuate comparison of the control state with the output state of the command module periodically at a predefined actuation period.

5. The system according to claim 1, wherein the relaxation module comprises a first sub-module configured to determine the activation duration, the first sub-module including:
a transistor, comprising a command connected to a voltage-dependent line of the command of the power transistor, a first and a second terminal;
a first resistance connected between the command and the first terminal of the transistor, a second resistance connected between the second terminal of the transistor and a first node, and a fourth resistance connected between the first node and the ground;
a capacitive block comprising a first capacitor connected between the first node and the ground;
a voltage generator connected between the first resistance and the collector of the transistor;
a first inverting gate, comprising an input connected to the first node and an output connected to a second node.

6. The system according to claim 5, wherein the relaxation module comprises a second sub-module configured to determine the deactivation duration, the second sub-module including:
a third resistance connected between the second node and an output of the first sub-module;
a fourth transistor, comprising a command, a first terminal (D) connected to a command line of the power transistor to bypass the electrical command, and a second terminal connected to the ground;
a fifth resistance connected between the command and the second node;
a sixth resistance connected in parallel to the fourth transistor;
a third capacitor connected between the second node and the ground;
a diode comprising an anode connected to the second node and a cathode connected to the output of the first sub-module;
a second inverting gate, comprising an input connected to the second node and an output connected to the fifth resistance.

7. An electrical device comprising a system according to claim 1, and further comprising an electric load, wherein the system is located between the load and a ground, or wherein the system is located between the load and a polarisation voltage.

8. An aircraft comprising the electrical device according to claim 7.

9. A method for protecting a load actuation system against an over-current, the actuation system being according to claim 1, the method comprising:
activating an output state of the command module and emitting an electrical command by the command module, the electrical command being produced from command data, the electrical command actuating the power transistor to close the power transistor and to place a load level associated with the electric load to an activation value;
generating one or more relaxation oscillations, each relaxation oscillation being produced, upon occurrence of an over-current, by:
activating the power transistor in a linear operating mode during an activation duration, the activation duration being determined by the relaxation module, the load level being equal to a limit value during the activation duration;
opening the power transistor for a deactivation duration consecutive to the activation duration, the deactivation duration being determined by the relaxation module, the load level being zero during the deactivation duration;
detecting a modification in the load level by the control module after a delay applied by the filtering module, determining a control state by the control module as a function of the modified load level, and transmitting the control state to the command module via a control state signal;
comparing by the command module the control state with the output state; and
when the control state signal indicates deactivation of the load, and the output of the command module is in the active state, modifying the output state of the command module to the inactive state.
